(19) United States
(12) Patent Application Publication
(10) Pub. No.: US 2007/0296605 A1
(43) Pub. Date: Dec. 27, 2007

(54) Individual survival module

(76) Inventor: Mircea Manolescu, Bucharest (RO)

Correspondence Address: ERIC HANSCOM, 7395 PORTAGE WAY, CARLSBAD, CA, 92011, US

(21) Appl. No.: 11/176,907

(22) Filed: Jul. 8, 2005

(30) Foreign Application Priority Data
May 20, 2003 (RO) PCT/RO04/00009

(51) Int. Cl. G08B 5/22

(52) U.S. Cl. 340/825.36

(57) ABSTRACT

This invention is directed toward an individual protective module which provides protection against earthquakes, cyclones, terrorist attacks, acts of war and other natural and criminal disasters. The module comprises a parallelepiped frame with a dimensionally-stable structure which is constructed of highly fire resistant and structurally robust material with an outer, resistant, aerodynamic cover. Five faces of the module are closed, which the sixth, front face had a sliding protective shield through which the user can enter and exit. The module is equipped with oxygen and water reserves, electronic lighting, communication means, an electronic tracking system, and a battery. Because the module is dimensionally stable of difficult to deform or crush, it can be anchored to a fixed point of a building.

### CROSS REFERENCE TO RELATED APPLICATIONS

This application claims priority based upon PCT application number PCT/RO2004/000009, with a priority date of 20 May, 2003, a publication number WO 2005/003475 A2.

### STATEMENT REGARDING FEDERALLY SPONSORED RESEARCH OR DEVELOPMENT

This invention was not federally sponsored.

### BACKGROUND OF THE INVENTION

This invention is directed toward an individual protective module which provides protection against earthquakes, cyclones, terrorist attacks, acts of war and other natural and criminal disasters. The module comprises a parallelepiped frame with a dimensionally-stable structure which is constructed of highly fire resistant and structurally robust material with an outer, resistant, aerodynamic cover. Five faces of the module are closed, which the sixth, front face had a sliding protective shield through which the user can enter and exit. The module is equipped with oxygen and water reserves, electronic lighting, communication means, an electronic tracking system, and a battery. Because the module is dimensionally stable of difficult to deform or crush, it can be anchored to a fixed point of a building.

The problem of buildings collapsing upon their occupants has been around as long as buildings have been constructed. Many of the great innovations in building design were made in attempts to avoid this problem. Building collapses have been caused, beginning with ancient history, by natural disasters such as earthquakes, hurricanes, cyclones, volcanic explosions and the like.

With the invention of catapults and other medieval siege equipment, humans first gained the ability to physically knock down a structurally sound, massive fort. As humankind's ability to destroy grew with the inventions of gunpowder, dynamite, TNT, and now nuclear weapons, concurrently grew the danger that a building occupied by humans could be leveled due to wartime or criminal activities. As such, there has been a growing need for a device which affords building occupants a quick and safe escape should the building in which he/she is working be damaged or destroyed.

The prior has several examples of attempts to resolve this problem. First, there are a series of measures taken when constructing new buildings that are design to decrease the likelihood that buildings will partially or entirely collapse. These measures, which include out sizing the fittings and other elements which give resistance to the building, supporting the construction on rubber props which dissipate pressures which can destroy the building, and casting or molding rubber diaphragms in the gap between neighboring buildings to avoid the buildings entering into resonance with each other. These measures, however, are extremely costly and can, in most cases, be applied only to new buildings and cannot be efficiently applied to retrofit older buildings.

There are also a number of measures that can be taken to retrofit older buildings, but, as with the measures that can be incorporated into new buildings, will protect a user only to the point where the building is so stressed that the building collapses. The current invention, however, provides a method by which the user can be protected aftera building collapses. It is not always possible to retrofit and old building, but when such retrofitting is possible, there are many potential drawbacks. To retrofit an older building to improve its structural integrity can be very costly, take a long time to complete, and severely inconvenience the building occupants during the retrofitting. None of these disadvantages are found with the current invention. Additionally, while it is possible to strengthen both older buildings and buildings under construction, such actions only serve to protect the inhabitants up to the point where the building collapses; the current invention provides protection after such a collapse.

Some of the prior art includes modules, such as WO 01/53632, a “Rescue capsule for free standing installation in a building”. This invention teaches a semi-octagonal sectional capsule, built and installed during construction of the building, which can shelter a number of people, and come equipped with several access panels. While this invention does manage to provide a protective shelter for a number of people, its disadvantages include the fact that is a very heavy and large structure which is not mobile, and cannot be used in all buildings. Another disadvantage is that the structural design is does not represent the optimal configuration for ensuring maximum resistance. It also does not provide protection for people trapped in dusty or smoking environments along the lines of the oxygen mask provided by the current invention. Finally, the '632 patent does not provide means by which survivors can be localized under the ruins of the building.

Another relevant piece of prior art is FR-A-2 753 223, titled “Anti-earthquake security devices combination for the prevention, the protection and the individual salvation in the event of destructing earthquakes”. This invention teaches a metal cage, assembled from many pieces, which, as with the '632 patent, provides a very heavy and large structure which is not of a size suitable for a wide variety of buildings, and is to heavy that it potentially could overload the very building structure who collapse it was designed to provide protection from. Additionally, the resistance provided by this structure is not optimum because of the large pieces from which it is assembled which, in turn, force the assembler to use large section elements. Furthermore, because assembly of the unit involves the use of a considerably number of bolts, the bolt holes in the sectional elements weakens the elements, thereby weakening the structure. The '223 invention also has large openings which allow the dangerous intrusion of broken glass and other potentially dangerous flying objects. The design of the structure allows it to be deformed, and the massive amount of material and extensive construction time prevent the invention from being moved easily and inexpensively once it is assembled in place.

Also in the prior art is FR-A-1 408 922, entitled “The refuge for the climatization of the individual ambience”. This patent relates to an invention involving the creation of a protected space in the shape of, and of the approximate size of, a room, in which materials are leaned up against the sides as buffers. The size and construction of the invention provides some protection against crushing should the overlying building collapse, but not nearly the protection afforded by the current invention. Furthermore, the '922 patent provides little or no protection against flying objects such as broken glass, wood, and concrete. Finally, due to its elaborate construction materials and techniques, the invention would prove costly to construct and next to impossible to move once it was constructed.

Thus there has existed a long-felt need for the current invention, which provides a means by which occupants of a building can decrease the chance they will be injured or killed in a building collapse. The current invention provides just such a solution by having an individual protective module which provides protection against earthquakes, cyclones, terrorist attacks, and other natural and criminal disasters

### SUMMARY OF THE INVENTION

It is a principal object of the invention to allow the builders and owners of buildings in which people work or live to, during construction or as a retrofit, provide a survival module into which each occupant can move should his/her building become in danger of collapsing.

It is another object of the invention that the survival module be usable in building regardless of the means or method of destruction, including natural, war time, and criminal means.

It is an additional object of the invention that the module provides means to protect a user against fire and smoke.

It is a further object of the invention that the module provides a supply of water and oxygen, and an oxygen mask which the user can put on in case of extreme dust or smoke.

It is also an object of this invention that the module provides a means of communication powered by a source of power within the module and independent from any outside power sources they are not

with the outside world, to not only allow the trapped individual the psychological benefits of letting others know where he/she is, but also to facilitate rescuers finding the trapped user of the invention.

It is an additional object of the invention that the module is strong enough to withstand a substantial load being placed on it over a substantial time span.

It is a further object of the invention that a military versions of the invention with an external frame of Kevlar or some other bullet-stopping fabric, provides for a movable shelter for soldiers defending a military objective, such as a building, entrance, or gate, such that the soldier using the military version can sit in a very comfortable position with a gun and be protected against terrorist attacks.

It is also an object of this invention that the module provides a source of light.

It is an additional object of the invention that the module be able to maintain lighting and communications through use of a battery enclosed within the outer surface of the module.

It is a further object of the invention that the shape of the module is aerodynamic such that the module resists movement when exposed to high winds, such as those that would be found in a hurricane or cyclone.

It is also an object of this invention that the module provides a lounge chair in which the user sits.

It is another object of the invention that the lounge chair is specifically designed to allow blood circulation.

It is a further object of the invention that the module contains a real-time warning system.

It is an additional object of the invention that a user of the invention be protected from rescuers removing overlying pieces of concrete, wood, and other debris from the user, thereby allowing the rescuers to work with increased speed as they no longer have to be as concerned over whether their uncovering efforts will further injure or even kill a trapped survivor.

It is also an object of this invention that the module be inherently simple and easy to use and install, thereby making it a suitable purchase for a non-expert in the field of structural security and rescue operations.

It is another object of the invention that other versions of the module are available for other areas of a building, including but not limited to closets, elevators, and the like.

It is a further object of the invention that due to users' confidence in the module's protective abilities, in the event of a disaster there will be less panic as all the building occupants rush toward the building exits, but rather, all users not near an exit will follow the commands coming from the communication module system and retreat into their modules.

It is an additional object of the invention that the object be capable of manufacture in a variety of sizes, including small modules for children or pets, up to larger modules that can hold more than one person at a time.

It is also an object of this invention that the outer shell of the module protects the user against broken glass, flying debris, and other sharp and potentially injury-causing objects.

It is another object of the invention that the module is movable and light enough so that two average persons can move the module without any additional tools.

It is a further object of the invention that the invention allows a person to survive in a collapsed building for at least several days.

It is an additional object of the invention that the module provides a means of protecting building occupants which is not only cost effective but also easy and quick to install.

It is also an object of this invention that the module could be used to provide temporary housing to homeless persons, refugees, and others needing temporary but secure housing, for example, during cold winters.

It is a final object of this invention that the module be capable of manufacture at a reasonable price such that it makes economic sense for building designers and contractors to incorporate the modules, or a least the points of attachment for modules, into their designs and buildings, and for building owners and renters, along with individuals concerned for their own safety and insurance companies which insure buildings to purchase one or more modules and install them as retrofits into existing buildings.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a top view of the invention with the top cut away to show the internal portions of the invention.

FIG. 2 is a side view of the invention with the left side cut away to show a side view of the internal portions of the invention.

### DETAILED DESCRIPTION OF THE FIGURES

This invention is an individual protective module which provides protection against natural and criminal disasters. The module has a structurally solid frame with an aerodynamically designed outer shape which is constructed of fire resistant material. The module has six sides, five of which are structurally solid; the sixth is a sliding door through which the user enters and exits the module. The module is designed to support a user for several days of entrapment under debris from a building, and is equipped with oxygen and water reserves, an oxygen mask, electronic lighting, communication means, an electronic tracking system, and a battery. Because the module is dimensionally stable and difficult to deform or crush, it can be anchored to a fixed point of a building, and moved from location to location by two average sized humans without additional tools.

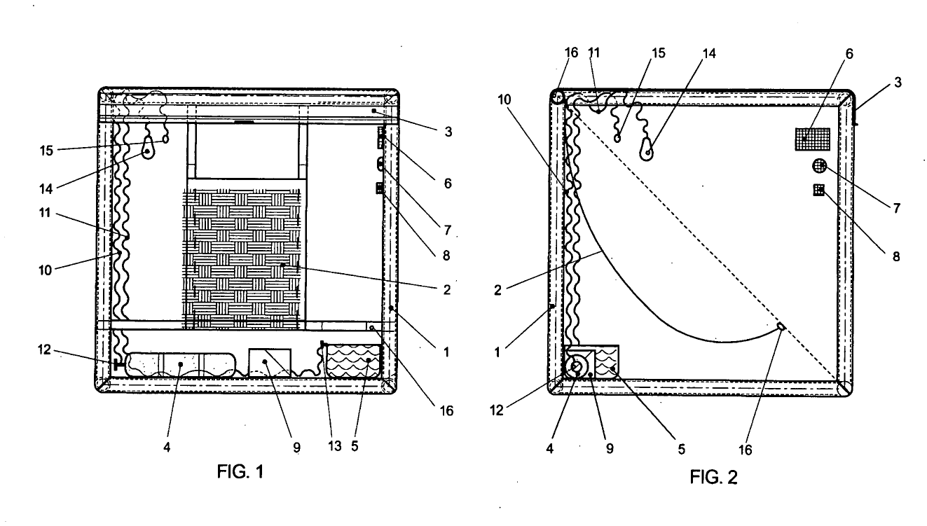

FIG. 1 is a top view of the invention with the top cut away to show the internal portions of the invention. The module has a parallelepiped frame (1), padded on the inside with any common cushioning material (not shown in this figure), with a seat (2), and an access door (3) through which the user enters and exits the module. The shape of the frame is aerodynamic such that its shape helps to deflect flying objects such that the module in many case will avoid any direct, frontal impact of big objects. The seat is a comfortable lounge chair, which has, optionally, a seat belt, and is attached to the frame (at points 16) with a cord or rope (not shown in this figure) looped through grommets in the seat and around the members of the frame. The cord or rope can, optionally, be made of a material that has some “give” or stretches slightly upon being pulled, such that if the module is dropped, such as during the collapse of a building, the fall is slightly cushioned by not only the padding on the inside of the survival module, but also the play in the cords or ropes. There is also an array of survival equipment, attached securely to the frame of the module, including an oxygen mask (14), attached to an oxygen tank (4) by an oxygen tube (10), where the flow of oxygen can be regulated by the user adjusting a regulator (12). There is also a drinking cup or outlet (15) attached to a water reservoir (5) by a water tube (11), an electrical lamp (6) to provide lighting to the module, and a communication module (7) which allows the user to maintain contact with family, friends, and rescuers while the module is covered by debris. The module also provides a real-time warning system module (8) which is used to transmit real-time warnings about an imminent catastrophe along with notices that a threat has passed. For example, if an earthquake is starting, the real-time warning system could alert all building occupants that an earthquake as started and that each occupant should proceed immediately to his/her module. After the earthquake has passed and the building safety/security inspectors have determined that it is safe to either resume work, or, in case of damage to the building, exit the building, this information will be transmitted to the module occupants through the real-time warning system module. All of the electronic modules in the invention are powered by a battery (9), which is connected to the power plant of the building, but which will provide at least several days of uninterrupted power to the module should the building's power plant stop functioning.

The communication module (8) consists of a real-time warning system and an electronic beacon which starts functioning immediately upon a disruption of power from the building's power plant or other triggering events, and begins sending the location and identification of that particular survival module to the relevant emergency response offices. The communication module also has an electronic device which sends out pre-recorded survival instructions for civil protection authorities and a safety telephone, walky-talky, or other means of communication powered by a source of power within the module and not dependent upon any outside source of power through which the user of the invention can keep in constant contact with outside rescue personnel along with friends and family. The safety telephone not only allows contact with the outside and enhances the security of the user through knowledge that a rescue effort is pending, but also reduces the likelihood that a user will panic based on not knowing what is happening on the outside of a collapsed building.

The real-time warning system can be triggered by a number of events, depending on how it is programmed, including external manipulation by military or emergency response personnel, a prolonged disruption of the building's power supply, or a physical event exceeding a certain parameter, for example, an earthquake measuring over 4.0 on the Richter Scale.

Optionally, the module can also be provided with food supplies (not shown in this figure), a thin sheet of additional fireproof material, blankets, pillows and other comfort supplies, a first aid kit, and other survival and comfort-related products.

FIG. 2 is a side view of the invention with the left side cut away to show a side view of the internal portions of the invention.

In the case of an imminent natural or criminal catastrophe, signaled by either the real-time warning system (8) or by personal ascertainment by the user of the invention, the user opens the access door (3), which can be a sliding or hinged door, and enters the parallelepiped frame (1) and sits upon the seat (2). The user can then, optionally, fasten himself/herself into the seat with an optional seat belt (not shown in this figure), then shut the access door (3), and, if deemed necessary, put on the oxygen mask (14), adjusting the flow through the regulator (12). Should the user get thirsty, he/she can drink from the water drinking cup or outlet (15) which is attached to the water reservoir (5) by the water tube (11). The water reservoir has an adequate supply of water to provide several days worth of water. The user can also turn on an electrical lamp (6) to provide lighting to the module.

During a catastrophe, when the power supply from the building gets interrupted accidentally or intentionally, the electrical lamp (6) and communication module (8) get activated automatically. The communication module begins to send out an intermittent signal which specifies the location and identification information on the module through an electronic beacon. The communication module also allows the user of the invention to send and receive survival messages from the outside world, and provides a connection with the external world until the end of the emergency situation and/or the arrival of the rescuers. Because the electronic beacon sends out accurate information as to the location of the module, and the user can assist rescuers by orally describing his/her surroundings (for example, by describing the smells or sounds occurring outside the module). Thus, between the electronic beacon and the user's ability to inform rescue personal of the fact that he/she is alive and his/her condition, the overall rescue effort for the entire building can be coordinated and efficient.

What I claim is:

1. A survival module for protecting the life of a user of the invention during a natural, wartime, or criminal disaster during which the structural integrity of a building in which the user occupies becomes threatened, comprising:
a frame, or shell of the module, padded on the inside, where the frame consists of five fixed, secure sides and one access door, where the frame is design and constructed adequately to withstand a substantial amount of building debris to fall and rest on it over at least three days without deforming or collapsing, and an external skin of fiberglass, carbon fiber, Keviar or another tough yet lightweight material which protects the user against broken glass, flying debris, and other sharp and potentially injury-causing objects,
a seat,
an array of survival equipment, including, an oxygen mask, an oxygen tube, an oxygen line, a regulator, a water dispensing device, a water line, a water reservoir, an electrical lamp which can provide lighting to the inside of the frame, a communication module with a real-time warning system which allows one or more forms of contact between the user of the invention and the outside world and transmits, upon activation, an electronic beacon which sends out a signal which identifies the particular module to which the beacon is attached and notifies emergency rescue authorities that the real-time warning system is functioning,
where, the oxygen mask is attached by the oxygen line to the oxygen tube, and where the flow of oxygen to the user of the invention can be controlled through the user's manipulation of the regulator,
where, the water reservoir feeds water to the water dispensing device through the water line,
where, the survival equipment is attached securely to the frame,
a battery, which is connected to an outside source of power, and which has adequate electrical capacity to power the module for at least three days following disruption of the outside source of power, and,
one or more means of attaching the device to a building, where, the means are such that the device can be, optionally, both incorporated into new buildings and retrofitted into existing buildings, and,
where, the survival module is light enough to be moved by two adult humans without the use of additional tools.

2. The frame of claim 1, where, the frame has a parallelepiped shape made from two or more triangular unbending primary elements.

3. The frame of claim 1, where, the shape of the frame is aerodynamic such that the design helps deflect flying objects such that it decreases the chances of a direct, frontal impact of big objects and such that the module resists movement when exposed to high winds, such as those that would be found in a hurricane or cyclone,

4. The access door of claim 1, where, the access door is a sliding door.

5. The access door of claim 1, where, the access door is a hinged door.

6. The seat of claim 1, where, the seat is a lounge chair designed for orthopedic support and is designed so as to not disrupt the circulation of blood throughout the user's body while the user is sitting in the seat, and where the seat is attached to the frame by one of more ropes or other materials which stretch slightly when pulled upon, thereby giving the seat some give should it be dropped from a substantial height, where the give is intended to provide protection to the user of the invention from injuries sustained due to compression when the module's fall is arrested.

7. The seat of claim 1, where, the seat includes a seat belt.

8. The forms of contact of claim 1, where, the one or more forms of contact between the user and the outside world includes means which allow the user to speak directly to rescuers, friends, family, and others on the outside of the module, and means which allow a person or persons outside of the module to call into the module and speak with the user of the invention.

9. The forms of contact of claim 8, where, the one or more forms of contact also include pre-recorded instructions that are triggered by the activation of the real-time warning system which instruct the user how to enter, secure, and use the module.

10. The communication module of claim 1, where the communication module additionally provides a real-time warning system which transmits real-time warnings about an imminent catastrophe to the user along with notices that a threat has passed.

11. The communication module of claim 1, where the communication module additionally provides an electronic device which sends out pre-recorded survival instructions for the users of the module.

12. The survival module of claim 1, additionally comprising food supplies and a first aid kit.

13. The survival module of claim 1, additionally comprising a thin sheet of additional fireproof material arrayed across the inside of the frame.

14. The survival module of claim 1, additionally comprising one or more blankets, pillows and other comfort supplies.

15. The survival module of claim 1, where, the module can be made in different sizes, based upon the size and number of intended occupants, and for other areas of a building, including but not limited to closets, elevators, and the like.

16. The survival module of claim 1, where, a military version of the module additionally comprises an external frame of Kevlar or some other bullet-stopping fabric, provides for a movable shelter for soldiers defending a military objective, such as a building, entrance, or gate, such that the soldier using the military version can sit in a very comfortable position with a gun and be protected against terrorist attacks.

17. A method of providing protection for an occupant of a building which is capable of collapsing due to natural, wartime, or criminal causes, comprising,
first, constructing a survival module comprising a frame with a parallelepiped shape consisting of five fixed, secure sides and one access door, where the frame is design and constructed adequately to withstand a substantial amount of building debris to fall and rest on it over at least four days without deforming or collapsing, a seat, and where, the frame includes as an integral part of the frame an outer shell which is a flat piece of material made of metal, fiberglass, carbon fiber, plastic or another suitable material which protects the user against broken glass, flying debris, and other sharp and potentially injury-causing objects,
where, the sides of the parallelepiped frame consist of two or more triangular unbending primary elements,
an array of survival equipment, including, an oxygen mask, an oxygen tube, an oxygen line, a regulator, a water dispensing device, a water line, a water reservoir, an electrical lamp which can provide lighting to the inside of the frame, a communication module which allows one or more forms of contact between the user of the invention and the outside world and transmits, upon activation, an electronic beacon which sends out a signal which identifies the particular module to which the beacon is attached and notifies emergency rescue authorities of the direction and the distance to the survival module and that the emergency beacon is functioning, and, a real-time warning system,
where, the oxygen mask is attached by the oxygen line to the oxygen tube, and where the flow of oxygen to the user of the invention can be controlled through the user's manipulation of the regulator,
where, the water reservoir feeds water to the water dispensing device through the water line, where, the survival equipment is attached securely to the frame,
a battery, which is connected to an outside source of power, and which has adequate electrical capacity to power the module for at least three days following disruption of the outside source of power, and,
one or more means of attaching the device to a building, where, the means are such that the device can be both incorporated into new buildings and retrofitted into existing buildings, and,
where, the survival module is light enough to be moved by two adult humans without the use of additional tools,
second, installing the survival module in the building,
third, installing the necessary infrastructure, including a power supply and communication means to local telephone systems and emergency rescue offices, and,
fourth, training emergency response crews and the occupants of the building to use the features of the survival module.

18. The method of claim 17, where, the survival module additionally comprises a seat belt, food supplies, a thin sheet of additional fireproof material arrayed across the inside of the frame, one or more blankets, pillows and other comfort supplies, and a first aid kit.

19. A method of providing protection for an occupant of a building which is capable of exposing the user of the invention to severe winds due to natural, wartime, or criminal causes, comprising,
first, constructing a survival module comprising a frame consisting of five fixed, secure sides and one access door, where the frame is design and constructed adequately to withstand a substantial amount of building debris to fall and rest on it over at least three days without deforming or collapsing, a seat, and where, the frame includes as an integral part of the frame an outer shell which is a flat piece of material made of metal, fiberglass, carbon fiber, plastic or another suitable material which protects the user against broken glass, flying debris, and other sharp and potentially injury-causing objects,
where, the shape of the frame is aerodynamic such that the module resists movement when exposed to high winds, such as those that would be found in a hurricane or cyclone,
an array of survival equipment, including, an oxygen mask, an oxygen tube, an oxygen line, a regulator, a water dispensing device, a water line, a water reservoir, an electrical lamp which can provide lighting to the inside of the frame, a communication module which allows one or more forms of contact between the user of the invention and the outside world and transmits, upon activation, an electronic beacon which sends out a signal which identifies the particular module to which the beacon is attached and notifies emergency rescue authorities of the direction and the distance to the survival module and that the emergency beacon is functioning, and, a real-time warning system,
where, the oxygen mask is attached by the oxygen line to the oxygen tube, and where the flow of oxygen to the user of the invention can be controlled through the user's manipulation of the regulator,
where, the water reservoir feeds water to the water dispensing device through the water line,
where, the survival equipment is attached securely to the frame,
a battery, which is connected to an outside source of power, and which has adequate electrical capacity to power the module for at least three days following disruption of the outside source of power, and,
one or more means of attaching the device to a building, where, the means are such that the device can be both incorporated into new buildings and retrofitted into existing buildings, and,
where, the survival module is light enough to be moved by two adult humans without the use of additional tools,
second, installing the survival module in the building,
third, installing the necessary infrastructure, including a power supply and communication means to local telephone systems and emergency rescue offices, and,
fourth, training emergency response crews and the occupants of the building to use the features of the survival module.

20. The method of claim 19, where, the survival module additionally comprises a seat belt, food supplies, a thin sheet of additional fireproof material arrayed across the inside of the frame, one or more blankets, pillows and other comfort supplies, and a first aid kit.
